(19) United States
(12) Patent Application Publication
(10) Pub. No.: US 2005/0165671 A1
(43) Pub. Date: Jul. 28, 2005

(54) Online trading system and method supporting heirarchically-organized trading members

(76) Inventors: Stephen M. Meade, Chicago, IL (US); Robert P. Gerometta, Riverside, IL (US)

Correspondence Address: MICHAEL K. LINDSEY;GAVRILOVICH, DODD & LINDSEY, LLP, 330 E. MAIN ST., SUITE 205, BARRINGTON, IL, 60010, US

(21) Appl. No.: 11/085,752

(22) Filed: Mar. 21, 2005

Related U.S. Application Data
(63) Continuation-in-part of application No. 09/539,830, filed on Mar. 31, 2000.

(51) Int. Cl. G06F 17/60

(52) U.S. Cl. 705/37

(57) ABSTRACT

An online trading system and method for establishing hierarchies of online trading units having plural levels of authority and available trading resources is disclosed. Each of the trading units represents part of a structured organization that trades goods and/or services, such as a global corporation, institution or government entity. The disclosed system and method allow large enterprises to conveniently integrate their purchasing and selling departments into an online trading environment, while maintaining a centrally-defined, hierarchical control scheme to appropriately limit and monitor the trading activities of the various departments.

This application is a continuation-in-part of U.S. patent application Ser. No. 09/539,830, filed on Mar. 31, 2000.

### TECHNICAL FIELD

The invention relates generally to online systems for exchanging goods and services, and in particular, to an online trading system for facilitating the exchange of products between structured organizations, such as large businesses, enterprises, government entities, or institutions.

### BACKGROUND

The dramatic increase in Internet usage has resulted in product markets becoming increasingly more immediate and competitive than ever before. The rise of e-commerce (commercial transactions carried out over computer networks) has resulted in lower transactional costs and improved market efficiencies in many instances.

A genre of e-commerce that is of particular importance is business-to-business (B2B) transactions, that is, transactions in which institutions or enterprises trade with one another. To facilitate and encourage B2B e-commerce, it is important that the enterprises' best commercial practices are emulated in the online trading environment. This contributes to increasingly efficient transactions.

It is common practice among enterprises to impose internal procurement policies, procedures and fiscal controls on their agents to ensure that commercial transactions are carried out in the enterprises' best interests. Despite the immense interest in facilitation of B2B e-commerce transactions, a cost-effective and easily implemented B2B solution that integrates e-commerce with enterprises' existing procurement and fiscal control procedures and policies is not generally available.

Accordingly, there is a need for an improved online trading system that readily adapts to and supports the fiscal, procurement and other internal control schemes that are typically employed within large organizations.

### SUMMARY

It is an advantage of the present invention to provide a system and method that allow institutions to conveniently integrate their purchasing and selling departments into an online trading environment, while maintaining a centrally-defined, hierarchical control scheme to appropriately limit and/or monitor the trading activities of the various departments in conformity with organizational policies, procedures and standards.

In accordance with an exemplary embodiment of the invention, an improved online trading system includes functionality for establishing and supporting online trading enterprises that have hierarchies of trading units (TUs). Each trading unit represents a commercial part of a structured organization, i.e., a part that trades goods and/or services. Each trading unit is assigned trading resources and privileges commensurate with its level of authority. Depending on their level in a hierarchy, the trading units have different levels of authority and resources for using the online trading system to trade goods and/or services. An administration application included in the trading system permits the creation of hierarchies and assignment of trading unit privileges and resources. Other applications in the trading system operate to enforce the limits of the assigned privileges and resources. By creating online structured trading entities with pre-assigned trading unit privileges and resources, the fiscal and procurement controls within a large institution can be greatly automated, along with the automation of the trade transactions themselves. This can reduce significantly the administrative costs associated with B2B commerce.

The foregoing general summary and the following drawings and detailed description are merely illustrative of the invention, rather than limiting. Other systems, methods, features, embodiments and advantages of the invention will be or will become apparent to one with skill in the art upon examination of the following figures and detailed description. It is intended that all such additional systems, methods, features, embodiments and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a conceptual block diagram illustrating an online trading system in accordance with an exemplary embodiment of the invention.

FIG. 2A illustrates an example of a trading unit hierarchy.

FIG. 2B conceptually illustrates the relationship between the member administration application shown in FIG. 1 and multiple trading unit hierarchies.

FIGS. 3-4 are flowchart diagrams illustrating the operation of the member administration and trading applications, respectively, shown in FIG. 1.

FIG. 5 illustrates an exemplary web page, displayed by the website shown in FIG. 1, for creating a trading unit.

FIG. 6 illustrates an exemplary web page, displayed by the website shown in FIG. 1, for entering information about a trading unit.

FIG. 7 illustrates an exemplary web page, displayed by the website shown in FIG. 1, for creating a new user.

FIG. 8 illustrates an exemplary web page, displayed by the website shown in FIG. 1, for managing existing trading units.

FIG. 9 illustrates an exemplary web page, displayed by the website shown in FIG. 1, for managing existing users.

FIG. 10 illustrates an exemplary web page, displayed by the website shown in FIG. 1, for displaying and allocating resources to trading units.

FIG. 11 is a contextual diagram of the website trading application shown in FIG. 1, showing details of its integration into an online trading system architecture.

FIG. 12 is a detailed block diagram showing components of the trading application of FIG. 1.

FIG. 13 is a context diagram of the transaction engine shown in FIG. 12.

FIG. 14 is a flowchart diagram illustrating operation of the transaction engine shown in FIGS. 12-13.

FIG. 15 illustrates an exemplary listing web page, displayed by the website shown in FIG. 1, for adding a product to be sold through the online trading system.

FIG. 16 illustrates an exemplary product search web page, displayed by the website shown in FIG. 1, for searching the product database of FIG. 12.

FIG. 17 illustrates an exemplary purchasing web page, displayed by the website shown in FIG. 1, for buying a product through the online trading system.

### DETAILED DESCRIPTION

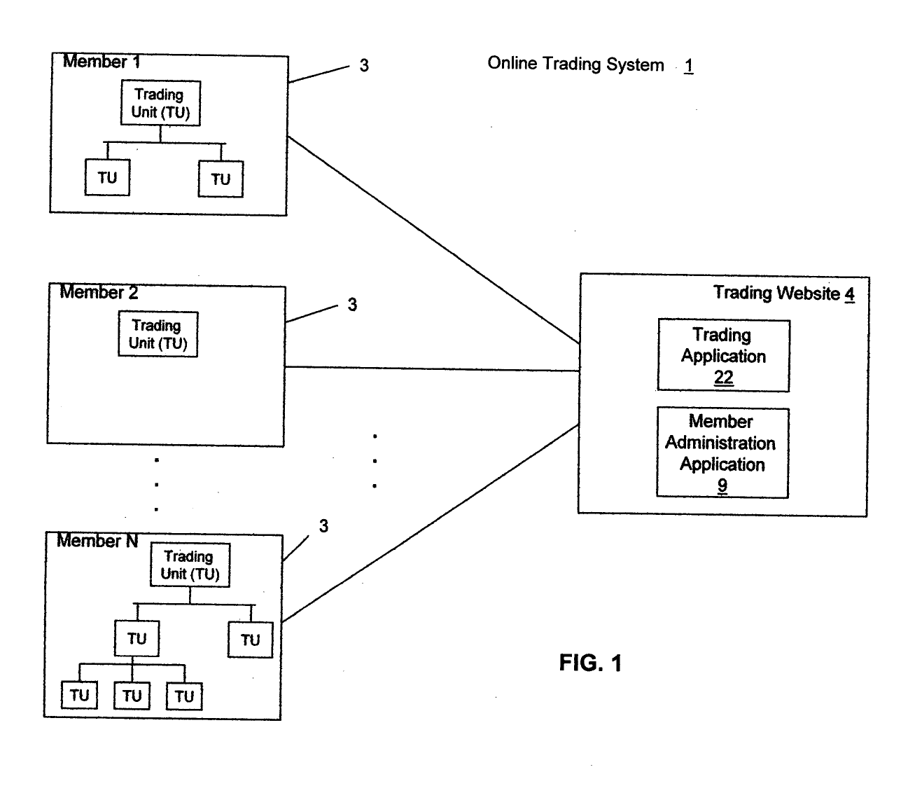

Turning now to the drawings, and in particular to FIG. 1, there is illustrated an online trading system 1 in accordance with an embodiment of the invention. The online trading system 1 includes a trading website 4 for facilitating the trade of goods and/or services between members 3 of the trading system 1. The trading website 4 includes at least one software program for establishing a hierarchy of trading units (TUs), such as a member administration application 9, and at least one software program for executing trade transactions between members 3, such as a trading application 22.

The members 3 are organizations, such as businesses, enterprises, government entities, institutions or the like, each including one or more persons or agents trading or otherwise engaging in commerce on behalf of the organization. Like many existing organizations, each member 3 is a hierarchically structured group of people engaged in a common or at least related undertaking. Depending on their levels in the organizational hierarchy, the groups within a member organization have different responsibilities and levels of authority and resources for carrying out the activities of the organization.

The online trading system 1 essentially captures the structured nature of real-world human enterprises and combines it with an e-commerce trading platform. The trading system 1 does this by allowing members 3 to create online trading units representing the groups of people in their respective hierarchy. Within the online trading system 1, each trading unit represents a part of a structured organization that trades goods and/or services. Using the member administration application 9, an authorized agent associated with each member 3 or a system administrator of the trading system 1 creates trading units and assigns various trading system rights and resources to the trading units in accordance with their authority level in the member's hierarchy.

As depicted in FIG. 1, the number of trading units and levels in a member hierarchy depends on the internal structure of the particular member. As described in further detail below, the member administration application 9 allows authorized agents to create, maintain and update hierarchies having any suitable structure, that is, having any suitable number of trading units and hierarchy levels. The online trading system 1 is not limited to representing any particular hierarchy or sets of hierarchies.

The trading website 4 itself can include one or more networked servers (not shown) configured to provide computer-based trading and the other functionalities described herein. The servers can be commercially-available servers running a standard operating system (OS), such as Windows NT or Unix. One or more software applications can be executed by the servers to provide the services and functions of the website 4 as disclosed herein. The services available to members can be implemented, at least in part, using active server pages (ASPs). The particular number of servers used and the manner in which they communicate with each other is a matter of design choice. Techniques for programming server computers are well known in the art.

The members 3 can access the trading website 4 over any suitable communications network using any suitable networking protocol and any suitable type of networked computing device, such as a personal computer (PC) or a wireless handheld device including, but not limited to, a personal digital assistant (PDA) or web-enabled cellular phone. Each networked device preferably includes a web browser and an operating system, such as Windows®, that permit data packet communications with the website 4 using conventional protocols such as the Transmission Control Protocol/internet Protocol (TCP/IP) and the Hypertext Transfer Protocol (HTTP).

The software applications executed by the trading website 4 server(s) can be stored in a computer-usable medium, such as a memory device selected from a solid-state memory, such as a RAM, ROM, EEPROM, or the like; a magnetic memory, such as a floppy disk, hard disk, tape, or the like; or an optical memory such as a CDROM or the like.

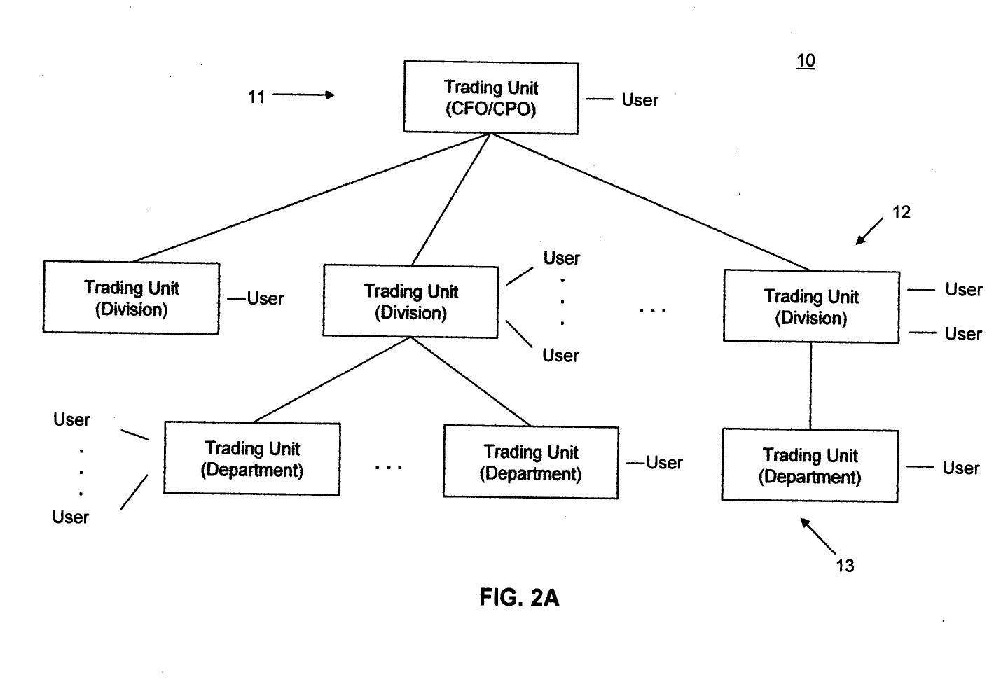

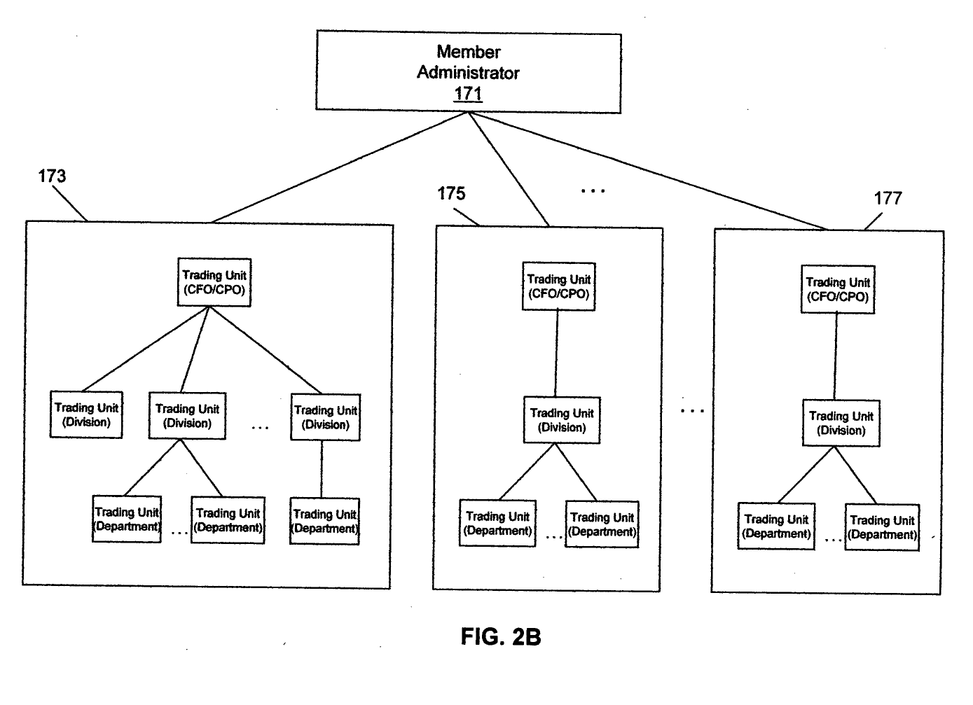

FIG. 2A illustrates an example of a trading unit (TU) hierarchy 10. The TU hierarchy 10 represents the organizational structure of one of the members 3 and is used to define the different levels of authority and resources that the member trading units have for using the online trading system 1. Each trading unit represents a commercial part of a structured organization, i.e., a part that trades goods and/or services. Each trading unit is assigned trading resources and privileges commensurate with its level of authority. Depending on their level in a hierarchy, the trading units have different levels of authority and resources for using the online trading system to trade goods and/or services.

In the example shown, the TU hierarchy 10 includes at least three levels: at the top, a chief executive level 11 (Chief Financial Officer (CFO) or Chief Procurement Officer (CPO)), then a division level 12, and next a departmental level 13. The rights and resources assigned to the trading units generally diminish moving down from the top of the hierarchy, but not in all circumstances.

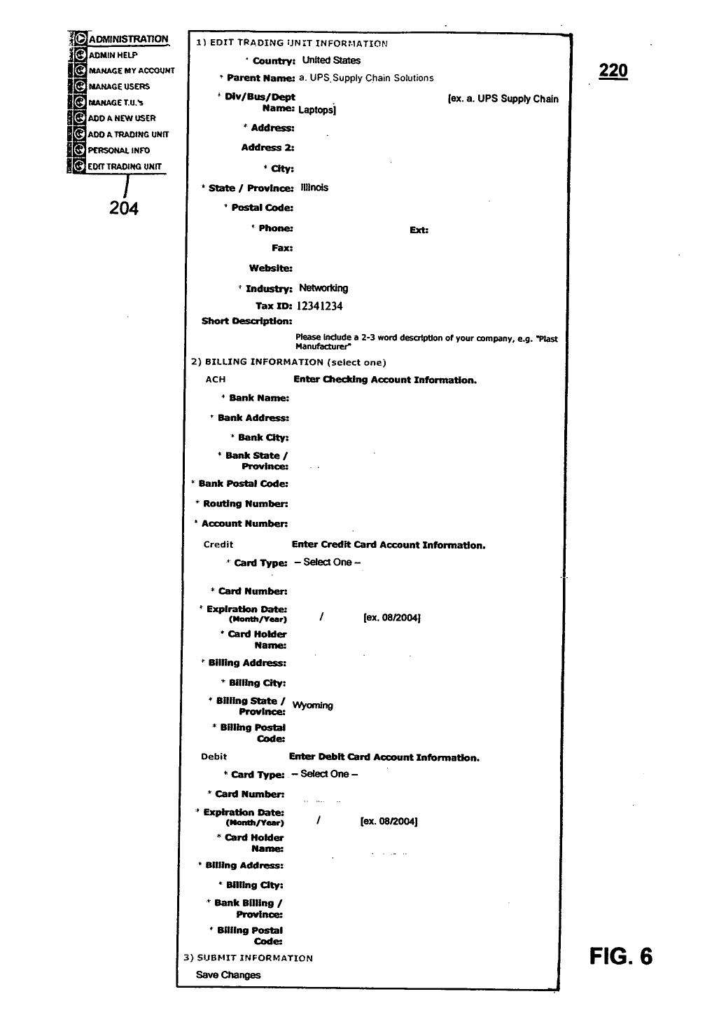

Each trading unit has an owner and one or more associated users. The TU owner can be authorized to add TU users and grant trading privileges to the users, who are the actual individuals, employees, assistants, administrators or agents of the member TU who engage in commerce using the trading website 4 (TU owners can also use the website 4 for trading). These users and their authority to use the trading website 4 are defined by an authorized agent, such as a member administrator, the TU owner itself or a TU owner higher up in the member hierarchy, as described below in connection with FIG. 7. Higher-level TU owners are responsible for authorizing lower-level TU owners to add users and grant user privileges. High level TU owners can add TU owners and users, as well as create subordinate TU hierarchies, at every level below their own level.

FIG. 2B conceptually illustrates the relationship between a member administrator 171 and multiple trading unit hierarchies 173, 175, 177. The member administrator 171, who is a duly authorized individual within a member organization 3 or within the website 4 administrative staff including an authorized agent, uses the member administration application 9 to create, maintain and update the hierarchies 173, 175, 177. The member administrator 171 is essentially a master member that has the authority to open any suitable number of hierarchies and create any suitable number of TUs and levels within the hierarchies.

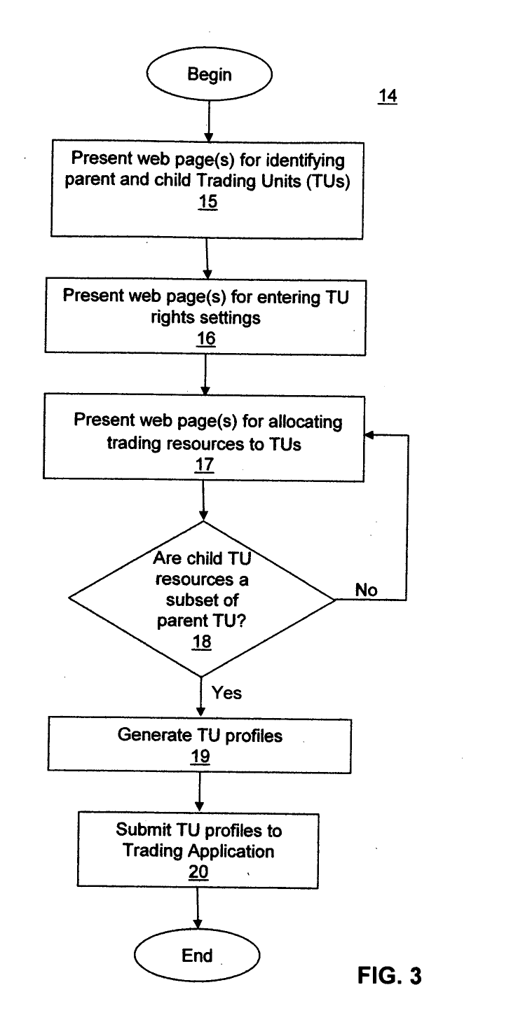

FIGS. 3-4 are flowcharts 14,21 illustrating the operation of the member administration and trading applications 9,22, respectively, of the trading website 4 shown in FIG. 1.

With reference to FIG. 3, the member administration application 9 allows authorized agents or the member administrator 171 to create TU hierarchies that are recognized by the trading website 4. For brevity, the following description refers only to authorized agents; however, it should be recognized that where reference is made to an authorized agent, the following description applies both to authorized agents and the member administrator 171.

In operation, the administration application 9 provides, over the Internet, one or more web pages to an authorized agent of the trading system 1. An authorized agent is one or more individuals who have been authorized to create trading units and/or TU hierarchies on behalf of a member organization 3. An authorized agent can be the designated owner of a particular trading unit. The member administration application 9 can identify authorized agents using website login and password protection techniques, which are well know in the art.

In step 15, the administration application presents web page(s), which include at least one fill-in screen, to an authorized agent through the Internet to allow the authorized agent to enter information identifying one or more parent trading units and one or more child trading units of a member 3. The parent-child association helps to define the relative relationships between trading units in a hierarchy. Parent trading units generally have greater trading authority and resources than their children trading units, and are located at higher levels in a member hierarchy. Child trading units are subordinate to their respective parent trading units in a hierarchy. They can inherit the authorizations and resources of a parent trading unit, and are preferably limited to a subset of the parent's authority and resources.

Preferably, a child trading unit is associated with a single parent trading unit, and a parent trading unit is associated with one or more children trading units. However, it is not intended that the invention be limited to any particular set of parent-child relationships between trading units. The inventive trading system contemplates hierarchies in which children trading units have more than one parent trading unit.

In addition to presenting web page(s) for establishing trading unit parent-child relationships, the administration application 9 can also present at least one fill-in screen to allow the authorized agent to enter information identifying one or more users associated with each of the trading units and one or more owners of the trading units. The administration application 9 can further present filling-in screens for entering specific trading unit information, such as contact information, tax information and billing information.

In step 16, the administration application 9 presents web pages that allow the authorized agent to enter rights settings for each trading unit in the member hierarchy. The rights settings define which online trading services of the website are available to the trading unit and its users. The rights settings authorize a trading unit and its users to use trading system services such as product searching, product listing, product buying, product selling, adding trading unit members and creating child trading units.

In step 17, the administration application 9 presents at least one web page fill-in screen to the authorized agent for allowing the authorized agent to enter information identifying trading resources allocated to each of the trading units. Generally, the trading resources are any items that can be traded in commerce. Specific examples of trading resources include inventory to be sold, allocated inventory balance (AIB), cash and online trade credits, which are negotiable only within the online trading system 1.

In step 18, the administration application 9 checks to ensure that the trading resources allocated to each child trading unit by the authorized agent are a subset of the trading resources allocated to the child's parent trading unit. If the child trading unit's resources are not part of its parent's resources, the proposed allocation is not recognized by the trading system 1 and the authorized agent is notified to correct the situation. The administration application 9 then re-presents the allocation web pages to the authorized agent (step 17).

Once the child trading unit resources are properly allocated, the administration application 9 proceeds to generate trading unit profiles for each of the trading units, based on the information and rights settings input by the authorized agent. The TU profiles are data files that are usable by the relevant application software running on the website 4. The TU profiles are stored within the website 4 or storage devices associated with the website 4.

In step 20, administration application provides the trading unit profiles to the trading application 22 of the trading website 4.

The trading application 22 of the trading website 4 processes trade transactions. In operation, the trading application 22 receives and processes trade requests from the trading units and their users. With reference to FIG. 4, in step 23, the trading application 22 receives one or more requests from the trading units. The trade requests include, but are not limited to, product search requests, product listing requests, product sell requests, product buy requests, add member requests, add user requests and add trading unit requests. If the request is a sell or buy request, it contains enough information to automatically carry out the commercial transaction, such information including the product quantity, product price, buyer/seller bank information (credit/debit card numbers, checking information, or the like), shipping information, and the like.

Upon receiving a request from a trading unit, the trading application 22 processes the request according to the trading unit's profile to enforce the rights settings and the allocated trading resources entered by the authorized agent (step 25). In this manner, the hierarchical organization of the trading units is maintained within the online trading system 1.

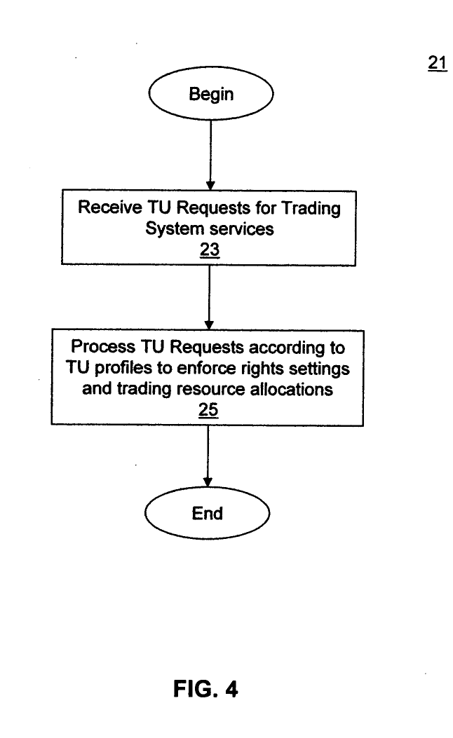

FIG. 5 illustrates an exemplary web page 200 for creating a trading unit. The member administration application 9 of the website 4 displays the web page 200 to an authorized agent. The web page 200 (as well as the other administration web pages 220,240,260,280,300) includes a pull down menu 204 for accessing the administrative functions offered by the member administration application 9. The web page 200 is accessed by clicking on the “Add A Trading Unit” button in the menu 204. The administration web pages 220,240,260,280,300 are accessible to a user when he/she logs into the website 4 using an authorized agent login ID and password.

Using the web page 200, the authorized agent can enter information about the trading unit in fill-in fields 206. The information includes the name of a user who is the owner of the trading unit and the owner's contact information, such as email address and phone number. The owner does not necessarily need to possess title or an interest in the trading unit, but may simply be the person within the member organization who is charged with responsibility for the trading unit.

The authorized agent can also enter further information about the trading unit, including the name of the trading unit and the identification of its parent trading unit.

The rights settings fields 208 permit the authorized agent to grant the trading unit owner usage privileges for various services offered by the trading website 4. The services that can be authorized include product searching, product listing (add products), product buying, product selling, and the capacity to associate new users to the trading unit (add users). Additionally, the authorized TU owner services can also include the right to create subordinate TUs and hierachies of subordinate TUs (not shown). A service is authorized by selecting the “yes” field next to the listed service. If the “no” field is selected, the corresponding service is not made available to the trading unit owner.

After entering trading unit information and selecting trading unit services, the authorized agent submits the trading unit information to the website 4 by clicking the submit button at the bottom of the page. The trading unit information is prospective until it is checked and verified against member records for consistency, accuracy and authenticity by a trading system administrator, such as the member administrator 171. This verification procedure can be performed manually or automatically. After trading unit verification is completed, the trading unit information is placed in a corresponding trading unit profile and the authorized agent and trading unit owner are notified by the trading system 1.

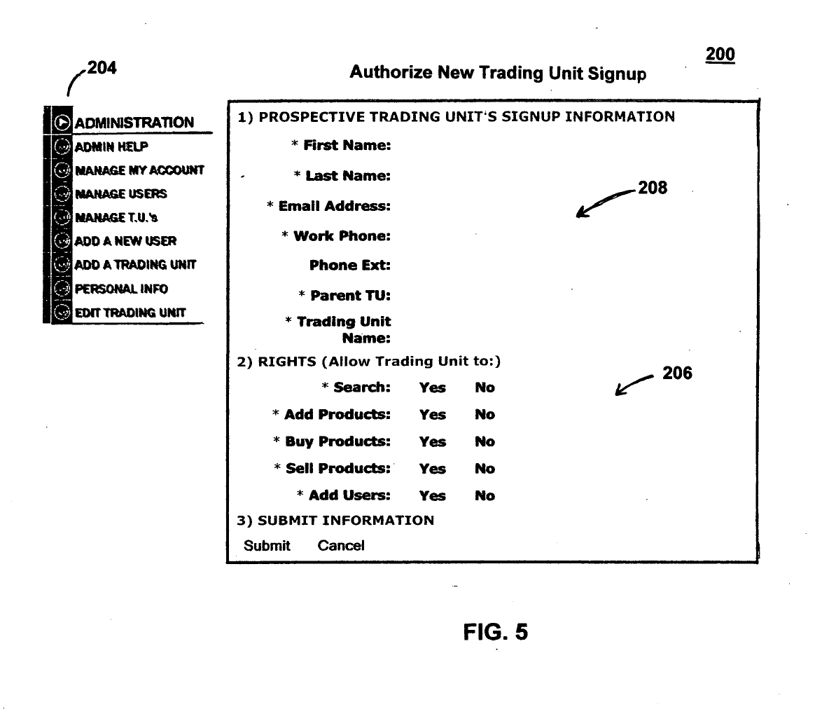

FIG. 6 illustrates another exemplary web page 220, displayed by the administration application 9, for entering detailed information about an existing trading unit. The web page 220 can be selected from the pull down menu 204 by clicking the “Edit Trading Unit” button.

The web page 220 displays any existing trading unit information stored in the TU profile in the relevant updatable fields. The fields allow an authorized agent or TU owner to enter or edit trading unit contact information and billing information. The contact information can include items such as the trading name, parent TU name, street address, phone number, fax number, e-mail address, and the like.

The billing information can include credit card, ACH, and debit card information, such as credit and/or debit card account numbers, bank names and account numbers, expiration dates and the like.

After an authorized agent or trading unit owner has finished editing trading unit information, an error check is provided by the administration application 9 to ensure that all the fields in the displayed page have been properly filled in. If the trading unit information contains no errors, the information is stored into the trading unit profiles stored by the website 4 for the respective member account.

FIG. 7 illustrates an exemplary web page 240, displayed by the administration application 9, for creating a new trading system user. The web page 240 can be accessed by clicking the “Add A New User” button on the pull down menu 204.

Using the web page 240, the authorized agent can enter information about the user in fill-in fields 246. In most cases, the authorized agent adding TU users is the TU owner. The information includes the name of the user, the user's contact information, such as email address and phone number, and the TU owner to whom the user is assigned. The authorized agent also assigns the user to an existing trading unit and a role in the trading unit, such as “buyer”, “seller”, “owner” or the like.

The rights settings fields 248 permit the authorized agent to grant to the user usage privileges for various services offered by the trading website 4. The services that can be authorized include product searching, product listing (add products), product buying, product selling, and the capacity to associate new users to the trading unit (add users). A service is authorized by selecting the “yes” field next to the listed service. If the “no” field is selected, the corresponding service is not made available to the trading unit.

After entering user information and selecting services, the authorized agent submits the user information to the website 4 by clicking the submit button at the bottom of the page. The user information is prospective until it is checked and verified against member records for consistency, accuracy and authenticity by a trading system administrator, such as the member administrator 171. This verification procedure can be performed manually or automatically. After trading unit verification is completed, the updated user information is placed in a corresponding trading unit profile and the authorized agent and trading unit owner are notified by the trading system 1.

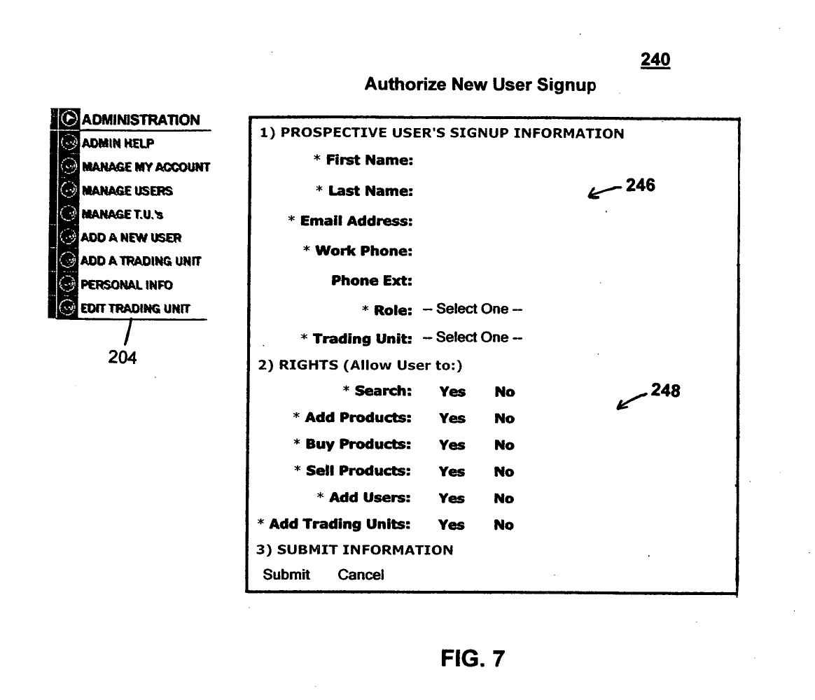

FIG. 8 illustrates an exemplary management web page 260, displayed by the administration application 9, for managing existing trading units. The web page 260 can be accessed by clicking the “Add A New User” button on the pull down menu 204.

Using the web page 260, the authorized agent can view summary information about the trading units in a member organization 3. The information includes the status of the trading units: “Active” indicates that the trading system administrator has completed its verification of the trading unit and “Pending” indicates that the review is not yet complete. The information also identifies the TUs' names and owners, as well as contact information. An “Edit” button is provided for accessing the TU edit page 220 and a “Delete” button is provided for deleting a trading unit from a member hierarchy. Also, a “New Unit” button is provided for accessing the trading unit signup page 200.

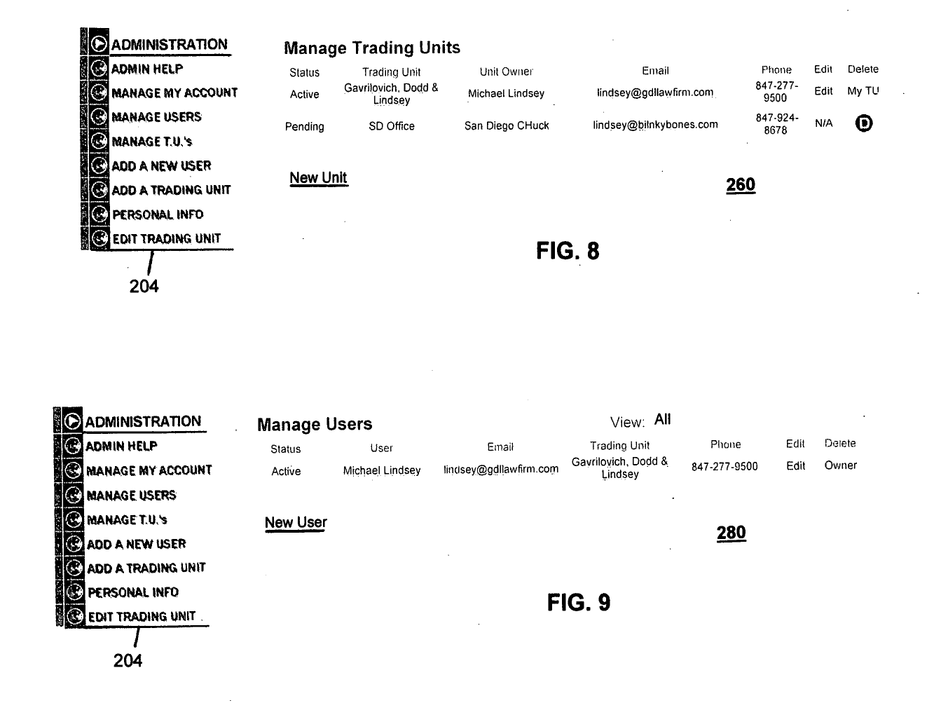

FIG. 9 illustrates an exemplary user management web page 280, displayed by the administration application 9, for managing existing users. The web page 280 can be accessed by clicking the “Manage Users” button on the pull down menu 204.

Using the web page 280, the authorized agent can view summary information about the users in a member organization 3. The information includes the status of the user: “Active” indicates that the trading system administrator has completed its verification of the user and “Pending” indicates that the review is not yet complete. The information also identifies the users' names and assigned trading units, as well as contact information. An “Edit” button is provided for accessing the user signup page 240 and a “Delete” button is provided for deleting a user from a member hierarchy. Also, a “New User” button is provided for accessing the user signup page 240.

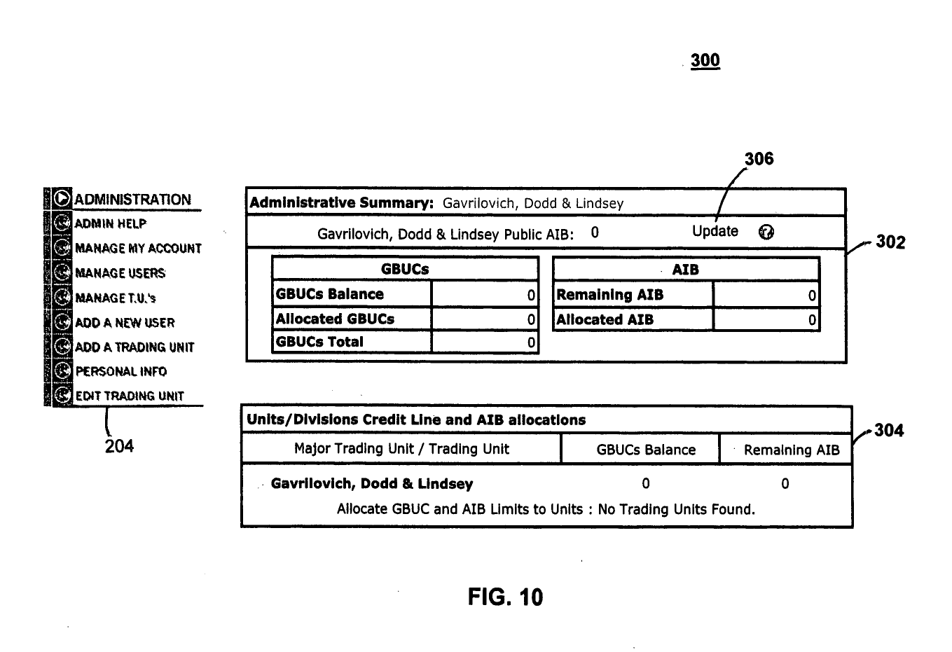

FIG. 10 illustrates an exemplary allocation web page 300, displayed by the administration application 9 for displaying and allocating trading resources to trading units. The trading resources include purchasing trade credits (GBUCs™) for use in commercial transaction within the system 1 and inventory and/or allocated inventor balance (AIB) for selling through the system 1. AIB indicates that amount of inventory that can be traded through the system using system trade credits (GBUCs™), rather than cash or other forms of currency.

The web page 300 includes an administrative summary table 302 showing the trade system purchasing credit balance (GBUCs™) and allocated inventory balance (AIB) for a member organization 3 at the highest level in its hierarchy. The GBUCs™ balance field indicates the current purchasing power of the member 3 within the trading system 1 after accounting for the members trading activity, while the allocated GBUCs™ field indicates the amount of purchasing power allocated to the member 3 by an authorized agent. The GBUCs™ total field shows the sum of the GBUCs™ balance and allocated GBUCs™ values. The remaining AIB field indicates the members currently available inventory for selling through the system 1 using GBUCs™, after accounting for the member's trading activity. The allocated AIB field indicates the amount of inventory allocated to the member by an authorized agent for trading on the system 1 using system trade credits.

A trade unit summary table 304 shows the trade credit and AIB balances for each member trading unit.

An authorized agent can update allocated trade credit and inventory amounts for the member or any of the trade units using the “Update” button 306. After entering allocated trade credit and AIB values, the authorized agent submits the resources information to the website 4. The administration application 9 checks to ensure that the trading resources allocated to each child trading unit are a subset of or equal to the trading resources allocated to the child's parent trading unit. The application 9 does this check by comparing information stored in the member and trading unit profiles.

If the child trading unit's resources are greater than its parent's resources, the proposed allocation is not recognized by the trading system 1 and the authorized agent is notified to correct the situation.

The allocated trading resources remain prospective until they are checked and verified against member records for consistency, accuracy and authenticity by a trading system administrator, such as the member administrator 171. This verification procedure can be performed manually or automatically. After trading resource verification is completed, the allocation information is placed in a corresponding trading unit profile and the authorized agent and trading unit owner are notified by the trading system 1.

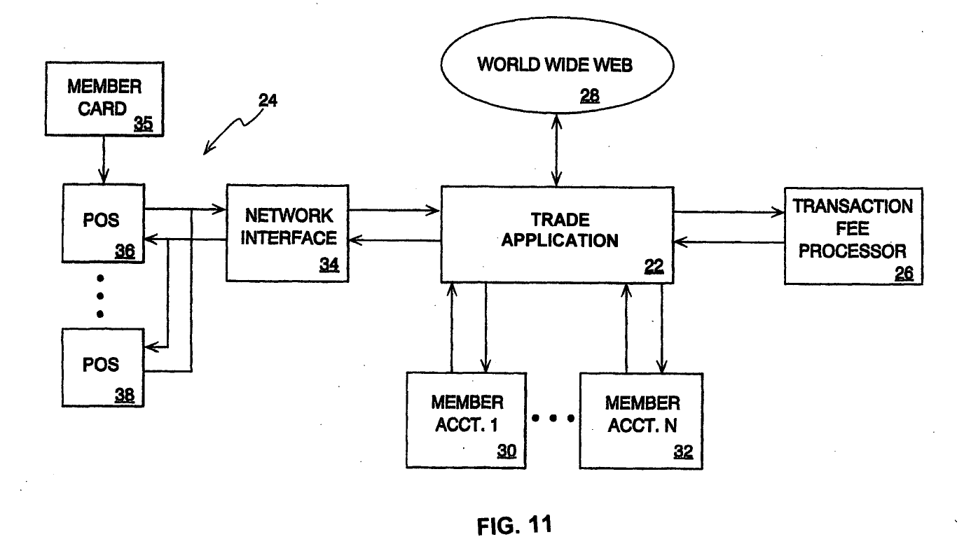

FIG. 11 is a contextual diagram of the website trading application 22 shown in FIG. 1, highlighting details of its integration into an exemplary online trading system architecture. The system architecture includes the trading application 22, a merchant point-of-sell (POS) network 24, and a transaction fee processor (TFP) 26. The trading application 22 can communicate with users by way of the World Wide Web (WWW) 28.

In this architecture, the trading application 22 can be accessed using pre-existing point-of-sale (POS) networks and conventional computer networks, such as the Internet. The TFP 26 allows the trading application 22 to automatically charge trade transaction fees to preexisting credit accounts held by member sellers.

The trading application 22 provides a computerized system for exchanging goods and/or services on a cash or non-cash basis. To effectuate non-cash transactions, the trading application 22 relies on an electronic form of currency called trade credits. Trade credits are intended for use only within the online trading system among participants carrying out non-cash transactions or split transactions involving both cash and trade credits. The trade credits can be Global Business Usage Currency™ (GBUCS™). Trade credit balances (TCBs) can be established for each member of the online trading system. The TCBs function essentially as debit accounts against which users can trade. Initially, a TCB can be established by the system administrator crediting a predetermined balance of trade credits to a member's account. Alternatively, a member's TCB may initially be zero, with the balance increasing only with a deposit or actual sale through the system made by the member.

A plurality of member accounts 30-32 can be maintained by the trading application 22 and member administration application 9 for maintaining TCB information for each member. Among other things, the member accounts 30-32 can include information about respective members, such as hierarchical structure of member trading units, trading unit, member and user profiles, member information tables, and standard identification information, such as name, address, phone, Tax ID, and the like. The member accounts 30-32 also include information pertaining to allocated inventory balances (AIBs) of members and their respective trading units.

The AIBs of sellers indicate the amount of inventory that a particular seller has available to trade on the system using GBUCS™. Thus, a potential seller or buyer can check AIBs associated with sellers or products to determine whether there is sufficient quantity of a particular good or service available in the trading application 22.

There are three (3) levels of AIB: an AIB limit set by the system administrator based upon the member buyer financial criteria; AIB threshold levels set by an authorized agent below or equal to the AIB limit-set by the system administrator; or AIB available, which is the AIB limit set by the system administrator or AIB threshold set by the authorized agent minus sales in a given monthly period.

In addition to purely non-cash transactions, the trading application 22 also supports cash transaction and split cash/non-cash transactions, as discussed in greater detail below.

For each transaction occurring within the trading system, a transaction fee can be assessed to one or more of the participants in the trade transaction. Preferably, the fee is charged to the seller. In the system shown in FIG. 11, the transaction fee can be assessed against a separate account held by the seller outside of the online trading system. The account can be a conventional credit card account in the sellers name. In this arrangement, a transaction fee charge can be submitted to a transaction fee processor 26, such as any well-known commercial network such as the Mastercard credit card network or the Visa card credit network for approval. The transaction fee processor 26 may be any of a plurality of financial institutions affiliated with and linked to such commercial networks for administering credit/debit cards issued by financial institutions. Additionally, ACH (automatic clearing house) transfers or letters of credit may be authorized.

To permit processing of the transaction fee, information provided to the transaction fee processor 26 from the trading application 22 would typically include data identifying a unique credit/debit card account number and the identity of the seller, as well as the merchant identity of the online trading system itself.

In response to receiving a transaction fee request, the transaction fee processor 26 returns an authorization code that either approves or declines the transaction fee charge. The trading application 22 can permit or prohibit the requested transaction based on the authorization code returned by the transaction fee processor 26.

The trading application 22 can also be interfaced to preexisting credit/debit card networks 24. To accomplish this, a network interface 34 is provided that permits communication with one or more POS devices 36-38. The network interface 34 can include conventional IO ports of a personal computer that are configured to communicate with standard credit/debit card networks. In this arrangement, trade requests can be submitted to the trading application 22 by buying members presenting a member credit/debit card 38 to a POS device 36-38 at a merchant that is also a member of the online trading system.

The POS devices 36-38 can be conventional credit card magnetic swipe readers capable of being connected to the credit/debit card network 24. The credit/debit card network 24 can be any of the standard networks currently being used by commercial financial institutions to provide credit/debit card services.

The trading application 22 is interfaced to the World Wide Web (WWWW) 28 using commercially-available TCP/IP-based networks, such as the Internet. As discussed above in connection with FIGS. 1-10, the web provides members with the ability to execute trades through the online trading system 1 using standard web browsers.

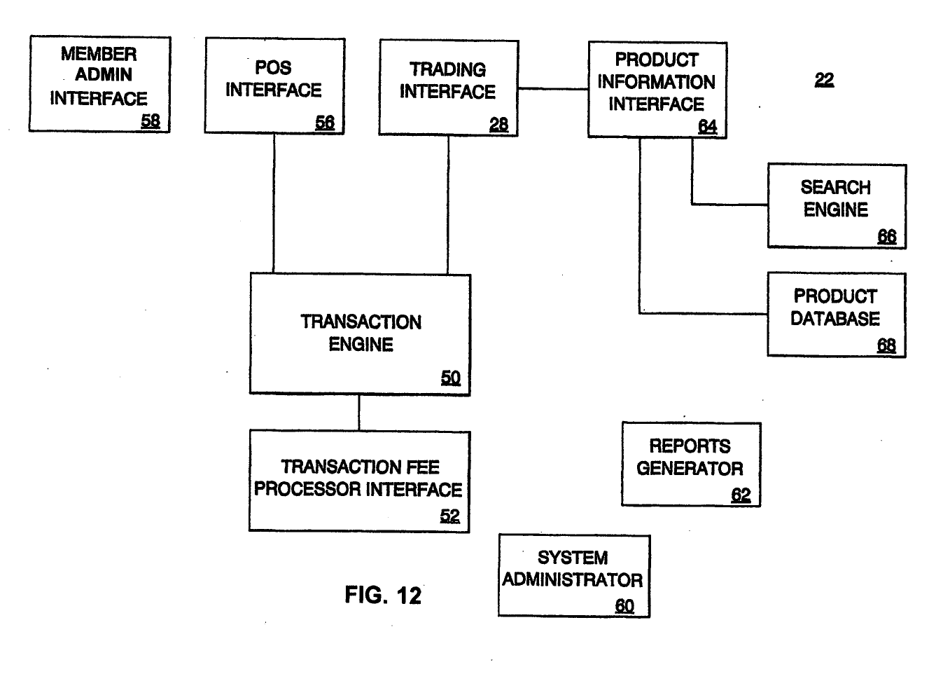

FIG. 12 is a detailed conceptual block diagram showing functional components of the trading application 22 of FIG. 1. The trading application 22 includes a transaction engine 50 communicating with a transaction fee processor interface 52, a trading interface 54, and a POS interface 56. The application 22 also includes a member administration interface 58, a system administration program 60, a report generator 62, and a product information interface 64. The product information interface 64 allows users to access a search engine and a product database 68. Each of the components shown in FIG. 12 is discussed in greater detail as follows.

The report generator 62 generates member monthly statements that include fields for displaying member information, TCB, and AIB. The report generator 62 also produces a sales list containing information on sales transactions that occurred during the month. A list of purchases shows information on purchases made by the member during the month. Year-to-date information is also displayed in the statement.

The member administration interface 58 provides an interface between the trading application 22 and member administration application 9 for exchanging member data, such as trade unit and user profile data, that is relevant to the execution of trade transactions.

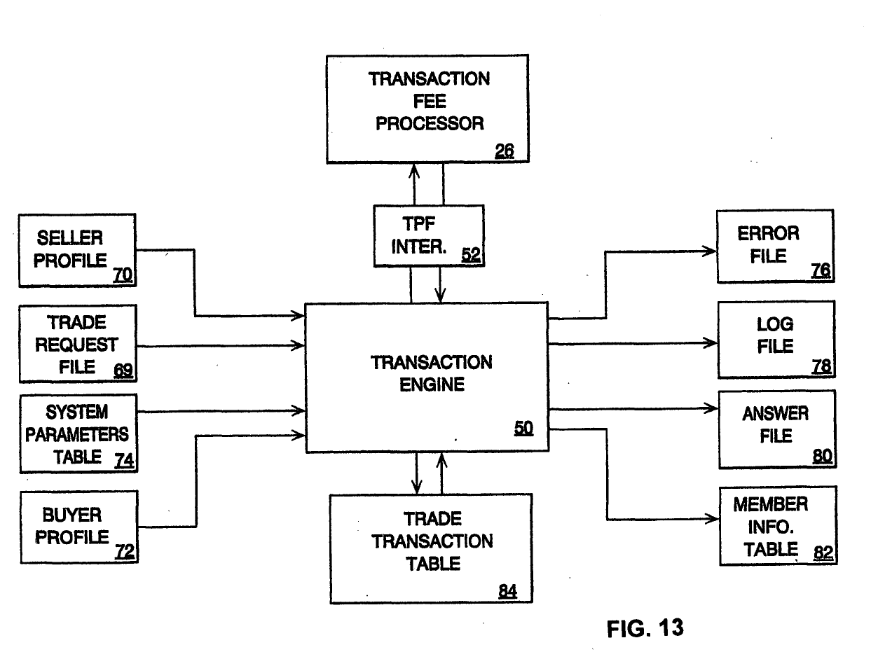

FIG. 13 is a context diagram of the transaction engine 50 shown in FIG. 12. The transaction engine 50 is configured to validate and authorize all trade transactions input to the trading application 22. The transaction engine 50 can be written as a Visual Basic 6.0 ActiveX DLL running as a service under the Windows NT operating system. The transaction engine 50 can be configured to respond to a transaction request, included in a trade request file 69, process the transaction, and then return a response to a requesting application. The requesting application can be another website server application.

The transaction engine 50 receives as input trade request files 69 that are stored in a pre-determined directory. To determine whether new trade requests have been received, the transaction engine 50 periodically scans the request directory at predetermined intervals for new trade request files 69.

A trade request file can include a transaction ID field, a trade date field, indicating the month, day and year of the transaction, and a total trade value field. The file format can be an ASCII delimited text file containing the above fields delimited by predetermined characters such as double quotes.

In addition to creating the trade request file 69, the server application can also update a trade transaction table 84. A trade transaction table can be generated for each trade, and can include the following fields:

| FIELD | DESCRIPTION |
|---|---|
| Transaction ID | An arbitrary number set by the trading |
| | application 22 for identifying the transaction. |
| Trade Transaction | The date/time of the transaction. If the |
| Date | transaction was initiated from the POS |
| | network, it should be the date received from |
| | the POS network transmission. |
| | Trade Type “S” = System Trade, “N” = Network |
| | Trade. |
| Trade Type | “S” = System Trade; “N” = Network Trade. |
| Trade ID | For system trades (“S”), this will be a trade ID |
| | set by the system. For network trades (“N”), |
| | this field is set to 0. |
| Buyer ID | The identification of the buyer. |
| Seller ID | The identification of the seller. |
| Total Trade Value | The total value of the trade. |
| Approval Status | Set by transaction engine after processing. |
| Approval Code | Set by transaction engine after processing. |
| Approval Date | Set by transaction engine after processing. |
| Merchant ID | The identity of a Merchant Business and the |
| | card processing information. |
| Terminal ID | The identity of individual POS terminals for |
| | debit/credit card processing. |

Although the data appearing in the trade transaction table 84 and the trade request file 69 appear to be redundant, the data is used by the transaction engine 50 to perform a checksum to protect against unauthorized trade request files. For each incoming trade request file, the transaction engine 50 performs a checksum conversion on the trade date field and compares that to a similarly calculated checksum for the same data included in the trade transaction table 84. If the checksum is invalid, the transaction engine 50 sets the approval code to indicate a transaction format error “invalid trade date” and declines the transaction. The transaction engine 50 can likewise perform a similar check between the transaction values and total trade values included in the trade request file 69 and trade transaction table 84. If all of the values in the trade request file 69 convert to valid checksum values, the transaction engine 50 proceeds to process the transaction request included in the file 69. If the engine 50 determines that any of the checksum values are invalid, it issues an approval code indicating a transaction format error and declines the transaction.

The transaction engine 50 also accesses a system parameters table 74 to determine whether the trade amount in the trade request file 69 meets a minimum threshold value. The parameters table 74 includes trade minimums for both system and network trades. If the trade is a system trade, then the trade amount cannot be lower than a value found in the minimum system trade parameter included in the table 74. If the trade is a network trade, then the trade amount cannot be lower than the value found in a minimum network trade parameter included in the table 74. If the trade amount value in the file 69 is lower than the respective minimum amount, then the transaction engine 50 sets the approval code to “Low Transaction Amount” and declines the transaction.

A seller profile 70 contains information on the seller status, allocated inventory balance (AIB), and trade credit balance (TCB). The profile includes information from a trading unit or user profile and it is identified by the seller ID field included in the transaction table 84. The seller status can be set to either active or inactive. If the seller status is active, the transaction engine 50 permits the transaction to go forward; otherwise, if the status is “inactive” the transaction engine 50 will decline to request a transaction. A seller can be inactive as a buyer only, as a seller only, or for both.

A buyer profile 72 can include buyer status and TCB information about the buyer initiating the trade request. The buyer profile 72 includes information from a trading unit or user profile and it is identified by the buyer ID included in the trade transaction table 84. Similar to the seller status, the transaction engine 50 can either approve or decline a proposed transaction based on the buyer status. Likewise, the transaction engine 50 can also approve or decline a proposed transaction based on the buyer's TCB.

The transaction engine 50 can determine a transaction fee and create a billing transaction between the trading application 22 and the transaction fee processor 26. The transaction engine 50 determines whether the fee is greater than zero and then creates the billing transaction. The fee can be billed to either the buyer or seller, but is preferably billed to the seller's separate credit account, or as an ACH deduction from the seller's bank account or from a letter of credit owned by the seller. In this latter arrangement, the transaction engine 50 accesses a transaction fee processor interface 52 and submits the seller ID and fee amount thereto. The transaction fee processor interface 52 retrieves the appropriate information for the seller, such as credit card account information to the seller's separate credit account, or as an ACH deduction from the seller's bank account or from a letter of credit owned by the seller, which can be stored in the seller profile 70. The fee amount and the appropriate credit account information are then encapsulated into a standard format for transmission over a commercial network to the fee processor 26, which can be a traditional credit card financial institution, such as a bank.

If any system error has occurred during the processing of a transaction request, the transaction engine 50 generates an error file 76 indicating the error. System errors include operating system errors, directory structure errors, initialization file errors, and the like.

The transaction engine 50 can also generate a log file 78 to which it logs information regarding each step the engine 50 performs in processing a transaction request.

An answer file 80 can be generated when the transaction request has been completely processed by the engine 50. The answer file can be identified using the transaction ID. The file format can be ASCII delimited text containing the following information: transaction ID, transaction date, trade ID, approval status, and approval code. The information included in the answer file can be used by the server application to display the trade approval form to the trade requestor. The form can be displayed using a conventional interface, such as a web browser or in the case of a POS network, a terminal display.

The approval code can be any of the following:

| CODE | DESCRIPTION |
|---|---|
| A | Approved |
| D1 | Buyer payment declined |
| D2 | Seller payment declined |
| D3 | Insufficient buyer TCB |
| D4 | Insufficient seller AIB |
| D5 | Member hold status |
| D6 | Member status not active |
| D7 | Low transaction amount |
| D8 | Transaction format error |
| D9 | System error |

After processing a requested transaction, the engine 50 can update information in the trade transaction table 84. The updated information can include the approval status, the approval code, and the approval date. The approval status can be either “approved” or “declined”. The approval code can be any of those listed above.

The engine 50 can also update member information tables 82 for the buyer and seller. The engine 50 can update the following fields in the member information table for the seller: trade credit balance, month-to-date sales, year-to-date sales, month-to-date trade volume, and year to date trade volume. The engine 50 can likewise update similar fields included in the member information table for the buyer. This buyer and seller information is then used to update trade unit and/or user profiles.

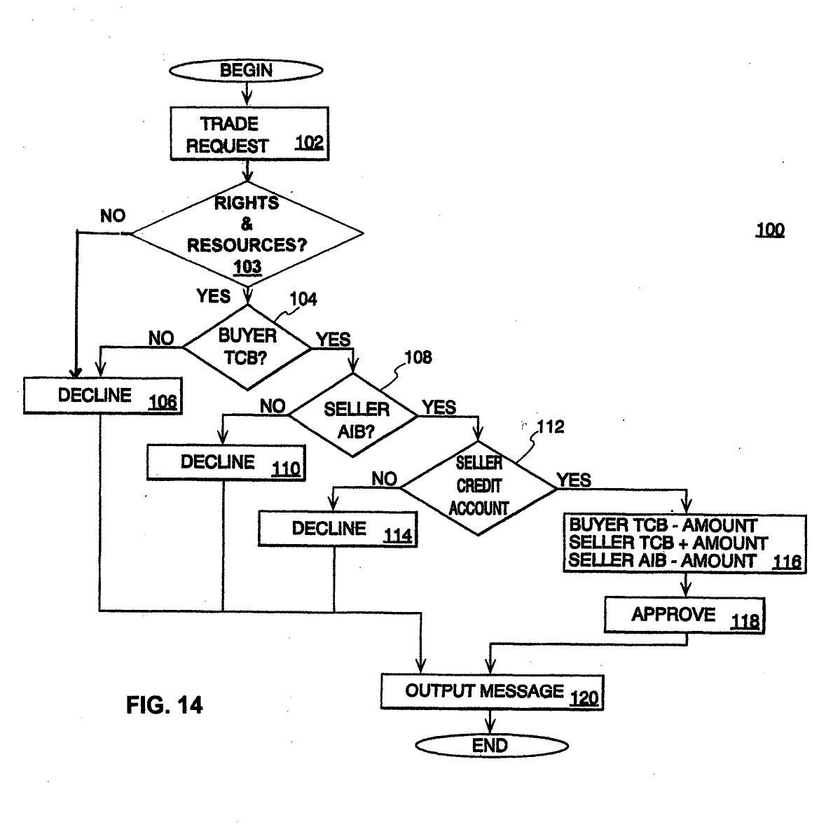

FIG. 14 is a flowchart diagram illustrating the operation of the transaction engine 50 in processing a trade request. Initially, a trade request is received by the transaction engine 50 (step 102). As described in connection with FIG. 13, the trade request can include the trade date, the transaction ID, and the total trade value. The transaction ID references the transaction table 84 to obtain the buyer ID and seller ID. The buyer ID and seller ID are used to retrieve information on the buyer TCB and seller AIB.

In step 103, a check is made to determine whether the granted trading rights and resources of the participants' trading units are sufficient to permit the requested transaction. This is done by comparing information in the trade request with information in the trade unit profiles of the buyer and seller. If either the buyer or seller is not authorized to participate in the requested transaction or they lack the requisite trading resources, the transaction is declined (step 106) and the transaction engine 50 issues an output message (step 120) indicating insufficient TU resources and/or rights, whichever the case may be.

In step 104, a check is made to determine whether the buyer TCB is sufficient to cover the requested transaction. If not, the transaction is declined (step 106) and the transaction engine 50 issues an output message (step 120) indicating insufficient buyer TCB. The engine 50 can also update the transaction table 84 to indicate the status of the proposed trade. However, if the buyer TCB is sufficient, the engine 50 proceeds to check whether the seller AIB is sufficient to cover the transaction (step 108). If not, the transaction is declined (step 110) and an output message is generated indicating insufficient seller AIB (step 120). However, if there is sufficient seller AIB, the transaction engine 50 proceeds to check whether the seller has sufficient credit available in a separate account (credit card, bank account, letter of credit, or the like) to cover the transaction fee (step 112). The transaction engine 50 can also retrieve the seller's product information file to see if selling authorization is required for the transaction to proceed.

The transaction engine 50 can compute the transaction fee as a percentage of the total trade amount of the requested transaction. The engine 50 can transport the transaction fee amount through conventional commercial channels to get approval from credit card issuing institutions for charging the fee to the seller's credit account, or as an ACH deduction from the seller's bank account or from a letter of credit owned by the seller. If the transaction fee processor 26 of the lending institution declines the transaction fee, the engine 50 accordingly declines the proposed trade (step 114). In this situation, an output message is generated indicating that the seller transaction fee has been declined (step 120).

Although it is preferable to charge the transaction fee to the seller, the transaction fee can also be charge entirely to the buyer, split between the buyer and seller, or charged to a third party.

If the transaction fee is approved, the engine 50 has completed its validation of the transaction and proceeds to update the trade table and member information tables (step 116). The transaction engine 50 does this by updating the buyer TCB, which is done by subtracting the amount of the transaction from the buyer TCB. Next, the seller TCB is updated by adding the transaction amount thereto. The seller's available AIB is decreased by the amount of the transaction. These updated values are then stored respectively in the trade table and member information tables.

For a successful transaction, an approval code and message are generated by the engine 50 (step 118). This information can be included in the output message generated by the engine 50 (step 120), as well as the answer file 80.

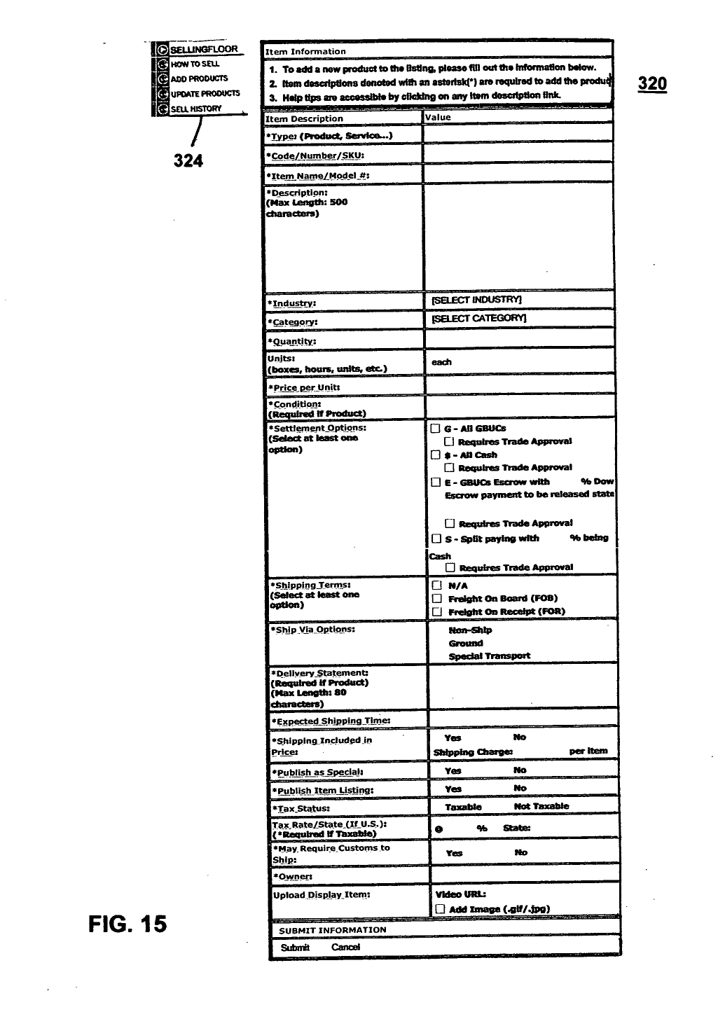

FIG. 15 illustrates an exemplary listing web page 320, displayed by the website 4 shown in FIG. 1, for inputting product information for a product that is to be sold through the online trading system 1. The listed products can include any good, service, currency, commodity, or the like. The web page 320 includes fields for inputting product information, such as the product name, SKU, description, category, unit price, number of units available, condition, and inventory status. The web page 320 also includes fields for entering settlement options and shipping terms. The settlement options fields permit sellers to select whether the products can be traded for trade credits, cash, or split transactions involving both trade credits and cash. Input fields are also provided to set minimum cash requirements for split transactions.

The product information enter using the web page 320 is stored in the product database 68 of FIG. 12.

The web page 320 also includes a pull down menu 324 for accessing the selling functions offered by the website 4.

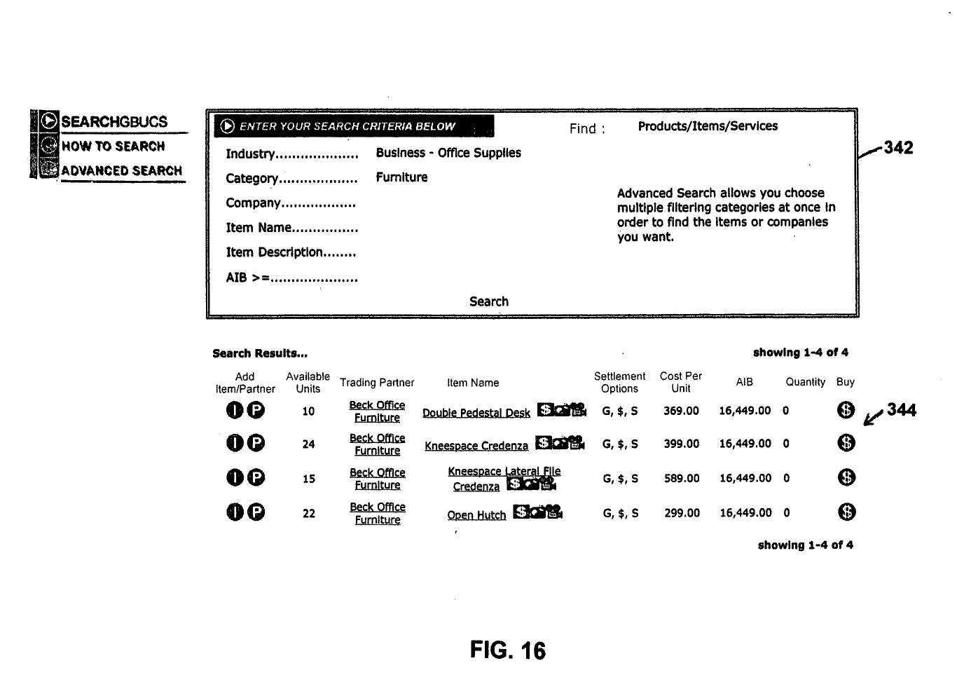

FIG. 16 illustrates an exemplary product search web page 340, displayed by the website 4, for searching the product database 68 of FIG. 12. The web page 340 includes a search input box 342 for allowing a user to access the search engine 66 to find information about products contained in the product database 68. A search results table 344 is included in the web page 340 to display production information retrieved as a result of a search.

The search engine 66 performs server database searches and is interfaced to website application software.

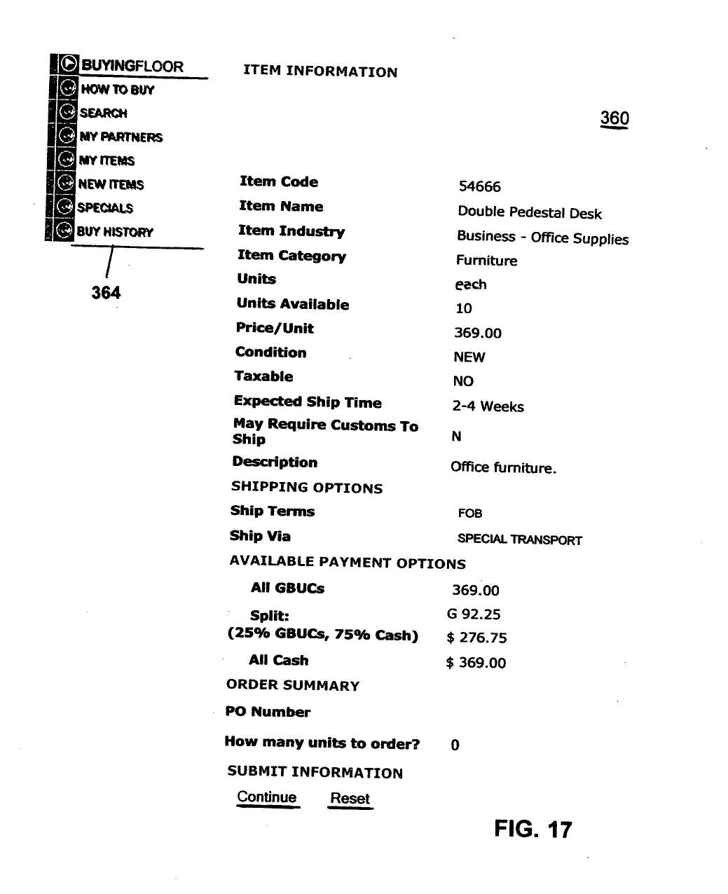

FIG. 17 illustrates an exemplary purchasing web page 360, displayed by the trading website 4, for buying a product through the online trading system 1. The web page 360 permits users to enter trade requests that are then processed by the trading application 22. The web page 360 displays information regarding the product involved in the transaction. The web page 360 also displays the available shipping and payment options in buyer selectable fields. Once a user submits the information entered through the web page 360 to the website 4, the trade requests in processed as described above.

The web page 360 also includes a pull down menu 364 for conveniently accessing the various purchasing functions offered by the website 4.

While specific embodiments of the present invention have been shown and described, it will be apparent to those skilled in the art that the disclosed invention may be modified in numerous ways and may assume many embodiments other than those specifically set out and described above. Accordingly, the scope of the invention is indicated in the appended claims, and all changes that come within the meaning and range of equivalents are intended to be embraced therein.

1. In an online trading system, a method of establishing a hierarchy of trading units having plural levels of authority and resources for using the online trading system to trade goods and services, each of the trading units representing part of a structured organization that trades goods and services, the method comprising:
providing at least one fill-in screen to an authorized agent through a computer network to allow the authorized agent to enter information identifying one or more parent trading units and one or more child trading units of the trading units;
providing at least one fill-in screen to the authorized agent through the computer network to allow the authorized agent to enter rights settings for each trading unit that define which online trading system services are available to the trading unit;
providing at least one fill-in screen to the authorized agent through the computer network to allow the authorized agent to enter information identifying trading resources allocated to each of the parent trading units;
providing at least one fill-in screen to the authorized agent through the computer network to allow the authorized agent to enter information identifying trading resources allocated to the child trading units;
using a software application to ensure that the trading resources allocated to each of the child trading units are a subset of the trading resources allocated to a corresponding parent trading unit;
receiving at a networked server the information and rights settings entered by the authorized agent;
generating trading unit profiles corresponding to the trading units based on the information and rights settings received at the networked server;
providing the trading unit profiles to a trading software application of the online trading system;
the online trading system receiving one or more requests from the trading units; and
the trading application processing the requests according to the trading unit profiles to enforce the rights settings and the allocated trading resources entered by the authorized agent.

2. The method of claim 1, further comprising:
providing at least one fill-in screen to the authorized agent through the computer network to allow the authorized agent to enter information identifying one or more users associated with each of the trading units and one or more owners of the trading units.

3. The method of claim 1, wherein the authorized agent is a trading unit owner.

4. The method of claim 1, wherein the rights settings include authorizing a trading unit owner to create one or more child trading units subordinate to the owner's trading unit.

5. The method of claim 1, wherein the child trading units inherit the rights settings of their corresponding parent trading units.

6. The method of claim 1, wherein the rights settings allow a trading unit to use one or more online trading system services selected from the group consisting of product searching, product listing, product buying, product selling, adding trading unit members and adding child trading units.

7. The method of claim 1, further comprising:
providing at least one fill-in screen to the authorized agent through the computer network to allow the authorized agent to enter information about each of the trading units selected from the group consisting of contact information, tax information and billing information.

8. The method of claim 1, wherein the requests from the trading units are selected from the group consisting of product search requests, product listing requests, product sell requests, product buy requests, add member requests, and add trading unit requests.

9. The method of claim 1, wherein the trading resources are selected from the group consisting of inventory to be sold, cash and trade credits negotiable only within the online trading system.

10. An online trading website for trading goods and services, the trading website capable of establishing a hierarchy of trading units having plural levels of authority and resources for using the online trading website, each of the trading units representing part of a structured organization that trades goods and services, the website including:
at least one software application for:
providing at least one web page to an authorized agent through a computer network to allow the authorized agent to enter information identifying one or more parent trading units and one or more child trading units of the trading units;
providing at least one web page to the authorized agent through the computer network to allow the authorized agent to enter rights settings for each trading unit that define which online trading services of the website are available to the trading unit;
providing at least one web page to the authorized agent through the computer network to allow the authorized agent to enter information identifying trading resources allocated to each of the parent trading units;
providing at least one web page to the authorized agent through the computer network to allow the authorized agent to enter information identifying trading resources allocated to the child trading units;
ensuring that the trading resources allocated to each of the child trading units are a subset of the trading resources allocated to a corresponding parent trading unit;
generating trading unit profiles corresponding to the trading units based on the information and rights settings entered by the authorized agent;
receiving one or more requests from the trading units; and
processing the requests according to the trading unit profiles to enforce the rights settings and the allocated trading resources entered by the authorized agent.

11. The website of claim 10, wherein the at least one software application includes:
means for providing at least one fill-in screen to the authorized agent through the computer network to allow the authorized agent to enter information identifying one or more users associated with each of the trading units and one or more owners of the trading units.

12. The website of claim 10, wherein the authorized agent is a trading unit owner.

13. The website of claim 10, wherein the rights settings include authorizing a trading unit owner to create one or more child trading units subordinate to the owners trading unit.

14. The website of claim 10, wherein the child trading units inherit the rights settings of their corresponding parent trading units.

15. The website of claim 10, wherein the rights settings allow a trading unit to use one or more trading website services selected from the group consisting of product searching, product listing, product buying, product selling, adding trading unit members and adding child trading units.

16. The website of claim 10, wherein the at least one software application includes:
means for providing at least one fill-in screen to the authorized agent through the computer network to allow the authorized agent to enter information about each of the trading units selected from the group consisting of contact information, tax information and billing information.

17. The website of claim 10, wherein the requests from the trading units are selected from the group consisting of product search requests, product listing requests, product sell requests, product buy requests, add member requests, and add trading unit requests.

18. The website of claim 10, wherein the trading resources are selected from the group consisting of inventory to be sold, trade credits negotiable only within the online trading website and cash.
